(19) United States
(12) Patent Application Publication
(10) Pub. No.: US 2017/0013846 A1
(43) Pub. Date: Jan. 19, 2017

(54) Edible Compositions and Methods of Making Same

(71) Applicant: Kristie Barrow, Andover, MA (US)

(72) Inventor: Kristie Barrow, Andover, MA (US)

(21) Appl. No.: 14/803,011

(22) Filed: Jul. 17, 2015

(51) Int. Cl. A21D 13/00; A23G 9/48; A21D 13/08

(52) U.S. Cl. CPC A21D 13/0019; A21D 13/08; A23G 9/485

(57) ABSTRACT

This disclosure relates to edible products and methods of making such compositions. The edible products disclosed herein comprise a first composition and a second composition in which the first composition surrounds a second composition. The second composition can be ice cream, frozen yogurt, or other desserts. The edible products disclosed herein allow for consumption of second composition without the mess associated with such dessert-like product.

### FIELD

This disclosure relates generally to edible compositions and methods of making such edible compositions.

### BACKGROUND

Edible products, particularly frozen, edible products are consumed across the world. Such products include yogurt, ice cream, Italian ice, freeze-dried products, and other types of confections. These products are part of a market that is $25 billion in the United States alone (see world wide web at foodnavigator-usa.com/Markets/US-ice-cream-and-frozen-dessert-market-tops-25bn).

Most frozen, edible products have the disadvantage of melting over time and creating a sugary substance that is very difficult to clean from surfaces. In some instances, melting can cause staining of clothing, furniture, in cars, and on other surfaces. In many instances, people purchase frozen concoctions for eating on the go—increasing the likelihood that the concoctions will be consumed such that they will lead to staining of surfaces.

Therefore, there remains a need to provide a frozen, edible product that allows for enjoyment of the product, but also saves time, money, and mess.

### SUMMARY

One aspect of this disclosure is directed to frozen, edible products that permit ingestion of the product while decreasing the likelihood of mess and rapid melting. The products disclosed herein are edible. In certain embodiments, the edible product comprises a composition that defines an outer surface and an inner region. Embodiments disclosed herein provide for the inner region being filled with a composition that is also edible. The outer surface can be edible to allow for consumption of the composition on the interior of the edible product.

An advantage of the disclosed compositions is that the outer surface protects from the interior composition making contact with the consumer of the product. This allows for the consumer of the product to avoid the composition becoming stuck to the consumer's fingers or staining furniture or other surfaces. For instance, a small child consuming an edible product comprising an ice cream interior will be able to consume the ice cream without rapid melting.

Aspects of the compositions disclosed herein include an edible product comprising a first composition shaped to define an exterior surface of the product and an interior region of the product; the interior region being filled with a second composition, wherein the first composition is sealed such that the second composition is within the interior region of the product. In certain embodiments, the second composition is not exposed to the exterior.

In some embodiments, the second composition comprises yogurt (e.g., low-fat yogurt), milk-based products, freeze-dried compositions (e.g., freeze-dried ice cream), fruit desserts, Italian ice, ice cream (e.g., low-fat, non-fat, and gluten-free ice cream), custards, cream-fillings, or other dessert concoctions. In particular embodiments, the second composition is ice cream. In more particular embodiments, the second composition comprises artificial or natural flavorings such as strawberry, blueberry, chocolate, cookie dough, vanilla, pistachio, walnut, peanut, hazelnut, and combinations thereof

In certain embodiments, the first composition is an edible pastry. In particular compositions, the edible pastry comprises one or more ingredients selected from the group consisting of sugar, eggs, milk, flour, nuts, honey, and water. In more particular embodiments, the pastry is a waffle, a wafer, or a pretzel. In some embodiments, the pastry is a sugar cone or other cone product. In still more particular embodiments, the pastry is formed from a single pastry sheet. In yet more particular embodiments, the pastry is formed from the sealing of a first pastry sheet to a second pastry sheet to form the product. The first can also be any flavor that is pleasing to the consumer.

In some embodiments, the product is in the shape of a sphere, triangle, rectangular box, disc, and any shape that allows for the definition of an exterior surface and an interior region. In embodiments disclosed herein, the first composition forms a pocket or pouch. In other embodiments, the interior region of the product is coated by a layer of a material that insulates the ice cream composition from the pastry. In particular embodiments, the material is selected from the group consisting of vegetable oil, sugar, chocolate, caramel, hazelnut, or combinations thereof. In more particular embodiments, the exterior surface of the product is coated with a hardened shell. In even more particular embodiments, the hardened shell comprises chocolate, caramel, Easymelt, or combinations thereof.

In certain embodiments, the interior region of the product is divided into two or more chambers. In particular embodiments, each chamber comprises a different ice cream composition. In other embodiments, each chamber comprises an ice cream composition having a different flavor from the ice cream composition in any other chamber.

### BRIEF DESCRIPTION OF THE FIGURES

To further understand the compositions and methods disclosed herein, reference is directed to the following brief description of the figures as well as the drawings that show exemplary embodiments of the compositions and methods:

FIG. 1 is a representation of the outside of an edible composition.

FIG. 2 is a cross-sectional representation of an edible composition.

FIG. 3 is a cross-sectional representation of an edible composition showing a composition comprising two chambers.

### DETAILED DESCRIPTION

Consumers of edible, dessert products have faced the problem that such products tend to be sticky and can create large messes. Particular issues occur when these products contain syrups and dyes. Such products can damage upholsteries, clothing, and furniture. Such issues are particularly acute when children are provided frozen desserts such as ice cream. The frozen product such as ice cream starts as a relatively easily handled solid, but melts into a sugary substance that contains substances such as chocolate, which can stain surfaces.

The disclosed compositions avoid many of these problems by providing the edible composition within a contained space. The disclosed compositions comprise a first composition and a second composition. In certain embodiments, the edible compositions are bite-sized. In other embodiments, the edible compositions are large enough to require multiple bites to fully ingest the composition.

The first composition can be edible. The first composition can further be a pastry. Examples of pastries included within the scope of this disclosure include waffles, wafers, pretzel materials, breads, cakes, cookies and any other dessert material that can be shaped to provide an exterior surface and an interior region. The first composition can also be formed into pastry sheets. The pastries disclosed herein can be comprised of one or more of sugar, flour, milk, eggs, nuts (e.g., peanuts and tree nuts), yeast, baking soda, baking powder, salt, and water. Additionally, the pastries can be comprised of any ingredient commonly used to allow for mass production. Non-limiting exemplary ingredients include high fructose corn syrup, cellulose gum, Polysorbate 60, and calcium sulfate. In particular embodiments, the first composition comprises natural and/or artificial flavorings.

The first composition also forms an exterior surface and interior region. The exterior surface faces the outside of the edible product. In certain embodiments, the first composition provides a protective “shell” for the second composition located within the interior region. The first composition also defines an interior region of the edible composition. The interior region can be formed by one or more first compositions sealed together to form the enclosed space. The sealant can be a sugar-based, edible seal. Alternatively, the one or more first compositions can be sealed together during the baking process to form the interior region.

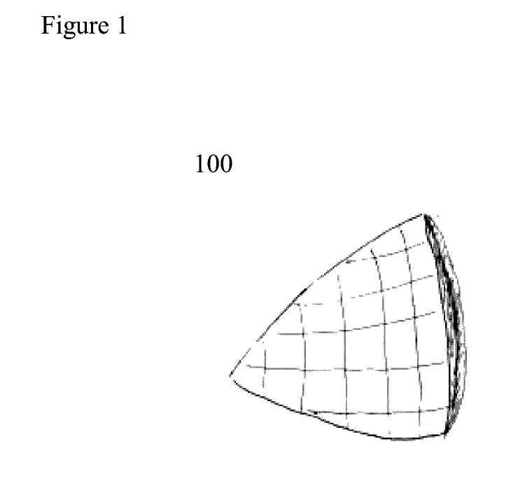

The edible product can be in any shape. Exemplary shapes include spheres, rectangles, discs, triangles, or any other shape that can made such that the edible product has an interior region that can hold a second composition. FIG. 1 shows a triangular-shaped composition 100. FIG. 1 shows only the exterior of the composition, which surrounds the interior region that contains the second composition (not shown). Molds for a variety of pastry shapes are known to those of ordinary skill in the art (see, e.g., F H W Franz Haas Waffelmaschinen Gmbh, Leobendorf, Austria).

The second composition in the edible product is an edible treat or dessert. Exemplary second compositions include cream-based products, milk-based products, freeze-dried products, sugary confections, custards, and other desserts or treats. In certain embodiments, the second composition is frozen. Non-limiting examples of frozen compositions include ice cream (non-fat, low-fat, reduced sugar), frozen yogurt, frozen custard, and Italian ice. The second composition can comprise natural and/or artificial flavorings. In further embodiments, the second composition comprises other ingredients such as strawberry, blueberry, chocolate, cookie dough, vanilla, pistachio, walnut, peanut, hazelnut, and combinations thereof.

The second composition can be placed into the interior region formed by the first composition by any means. For instance, the second composition can be injected into the first composition after it has been pre-formed into a shape. The second composition can also be placed onto the first composition prior to the first composition being molded into the final shape of the edible product.

In further embodiments, the interior surface of the edible product can be coated with a materials. The material can act as an insulating agent. Exemplary materials include oils, such as vegetable oil and canola oil, sugars, such as confectioner's sugar, caramel, hazelnut, and combinations thereof. The coating can be any thickness so long as it does not prevent ingestion of the second composition. Techniques for depositing the material on the interior surface of the edible product are well known in the art (see, e.g., Depositing Systems, F H W Franz Haas Waffelmaschinen GmbH, Leobendorf, Austria).

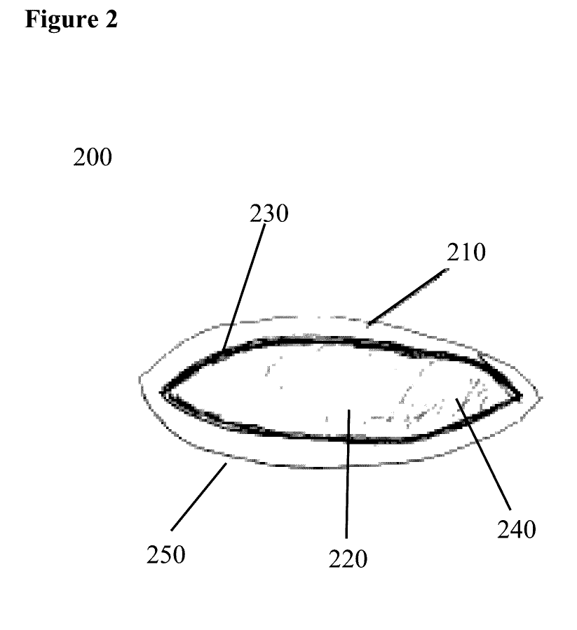

FIG. 2 shows the interior region of an edible composition 200. The first composition 210 forms an interior region 240 and an exterior region 250. The first composition 210 surrounds the second composition 220, which is a frozen edible composition.

The edible products disclosed herein can also comprise a coating on the exterior surface of the product. The coating can be any sugary, edible substance. In certain embodiments, the coating forms a hardened shell adhering to the exterior surface. Exemplary substances include chocolate, caramel, hazelnut, Nutella®, and combinations thereof. Returning to FIG. 2, the composition 200 comprises a coating 230 that is located between the first composition 210 and the second composition 220.

In additional aspects, the edible products comprise one or more chambers. For instance, the interior region of the edible product can be divided into compartments or chambers. The internal chambers can be separated by the first composition or by other compositions. The other compositions can be pastry sheets similar to the first composition.

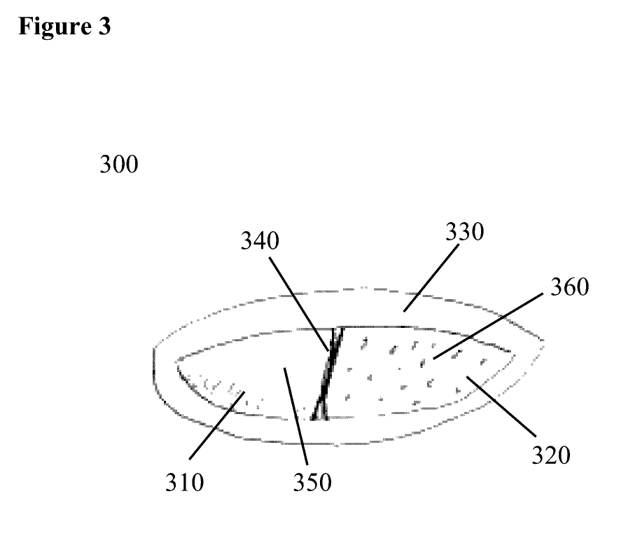

FIG. 3 shows an edible composition 300 comprising a first chamber 310 and a second chamber 320. The edible composition 300 comprises a first composition 330 that surrounds the first chamber 310 and the second chamber 320. The chambers 310 and 320 are formed by an interior edible divider 340. The first chamber is filled with a second composition 350 that is different from the second composition 360 that is in the second chamber 320. In this embodiment, there is a second 350 and third composition 360 surrounded by the first composition 330.

In particular embodiments, each compartment (i.e., chamber) of the interior region comprises a different second composition for the other compartments. For example, an edible product within the scope of this disclosure can comprise vanilla ice cream in a first chamber and chocolate ice cream in a second chamber.

It should be noted that the use of the term “a” or “an” means “one or more” throughout this application unless explicitly described otherwise.

### EQUIVALENTS

Those skilled in the art will recognize, or be able to ascertain, using no more than routine experimentation, numerous equivalents to the specific embodiments described specifically in this disclosure. Such equivalents are intended to be encompassed in the scope of the following claims.

1-24. (canceled)

25. An edible product comprising a first composition shaped to define an exterior surface of the product and an interior region of the product; the interior region being filled with a second composition, wherein the first composition is sealed such that the second composition is within the interior region of the product and wherein the edible product is bite-sized.

26. The edible product of claim 25, wherein the first composition is a pastry.

27. The edible product of claim 26, wherein the pastry is a pastry sheet.

28. The edible product of claim 25, wherein the first composition comprises one or more ingredients selected from the group consisting of sugar, eggs, milk, flour, nuts, honey, and water.

29. The edible product of claim 25, wherein the first composition is a waffle.

30. The edible product of claim 25, wherein the first composition is a wafer.

31. The edible product of claim 25, wherein the first composition is a pretzel.

32. The edible product of claim 25, wherein the interior region of the product is coated by a layer of a material to insulate an ice cream composition from the pastry.

33. The edible product of claim 32, wherein the material is selected from the group consisting of vegetable oil, sugar, chocolate, caramel, hazelnut, or combinations thereof.

34. The edible product of claim 25, wherein the exterior surface of the product is coated with a hardened shell.

35. The edible product of claim 34, wherein the hardened shell comprises chocolate, caramel, hazelnut or combinations thereof.

36. The edible product of claim 25, wherein the interior region forms a pocket.

37. The edible product of claim 25, wherein the first composition is formed from a single pastry sheet.

38. The edible product of claim 25, wherein the edible product is formed from the sealing of a first pastry sheet to a second pastry sheet.

39. The edible product of claim 25, wherein the interior region of the product is divided into two or more chambers.

40. The edible product of claim 39, wherein each chamber comprises a different ice cream composition.

41. The edible product of claim 39, wherein each chamber comprises an ice cream composition having a different flavor from the ice cream composition in any other chamber.

42. The edible product of claim 25, wherein the second composition comprises one or more of yogurt, milk-based products, freeze-dried compositions, fruit desserts, Italian ice, ice cream, custards, cream-fillings, or combinations thereof.

43. The edible product of claim 25, wherein the second composition comprises a flavoring selected from the group consisting of strawberry, blueberry, chocolate, cookie dough, vanilla, pistachio, walnut, peanut, hazelnut, and combinations thereof.

44. (canceled)
